(19) United States
(12) Patent Application Publication
(10) Pub. No.: US 2015/0130160 A1
(43) Pub. Date: May 14, 2015

(54) AMUSEMENT VEHICLE WITH ROWING-TYPE AUXILIARY DEVICE

(71) Applicant: HUIZHOU HUAER WANTONG INDUSTRY CO.,LTD., GANGDONG (CN)

(72) Inventors: JI LI, HUNAN (CN); SHERN-JI TSAY, KAOHSIUNG CITY 807 (TW)

(73) Assignee: HUIZHOU HUAER WANTONG INDUSTRY CO.,LTD., GANGDONG (CN)

(21) Appl. No.: 14/078,687

(22) Filed: Nov. 13, 2013

(51) Int. Cl. B62M 1/36

(52) U.S. Cl. CPC B62M 1/36
USPC 280/260

(57) ABSTRACT

An amusement vehicle with rowing-type auxiliary device mainly comprises a rotating apparatus pivotally disposed on the chassis and a controlling apparatus disposed on both sides of a seat of the chassis. The controlling apparatus comprises two controlling wheels pivoted on the chassis, a pair of transmission assemblages disposed on the chassis to drive the controlling wheel, and two controlling bars disposed to drive the transmission assemblages respectively. Each transmission assemblage includes a unidirectional device disposed on a driving gear which is connected to the controlling wheel. By using hands to cause a reciprocating movement of the controlling bars, the transmission assemblage drives the controlling wheels to rotate in one direction and move forwards. The rotating apparatus is controlled by stepping feet on to decide the moving direction. Therefore, users use hands and feet to obtain a self-propelling sliding motion, thereby increasing the exercise and amusement of the use.

### BACKGROUND OF THE INVENTION

1. Field of the Invention

The present invention relates to an amusement vehicle, particularly to an amusement vehicle with rowing-type auxiliary device which obtains the exercise of hands and feet in use.

2. Description of the Related Art

Referring to FIG. 1, a conventional amusement vehicle 1 comprises a steering bar 11, a supporting stem 12 opposite to the steering bar 11, a front wheel 13 pivoted on the steering bar 11, and two rear wheels 14 disposed at two sides of the supporting stem 12; wherein a handle 15 gripped by hands is disposed on the steering bar 11, and a seat 16 for sitting is disposed on the supporting stem 12 and connected to the steering bar 11. While using, a user sits on the seat 16, bends his knees for placing his feet on the steering bar 11, and then puts his hands on the handle 15. Then, the repeated wriggles of buttocks and the left-right reciprocating swings of hands drive the front wheel 13 and the rear wheels 14 to move forwards. However, the vehicle 1 is inconvenient in use because the user can only experience a partial exercise and need to operate in a bended gesture, which causes the user to be apt to feel monotonous and bored and causes the user unable to enjoy a fun of amusement and exercise.

### SUMMARY OF THE INVENTION

Accordingly, the purpose of the present invention is to provide an amusement vehicle with rowing-type auxiliary device operated by hands and feet at the time of using, thereby increasing the exercise and amusement of the use.

The amusement vehicle with rowing-type auxiliary device comprises a chassis, a rotating apparatus pivoted on the chassis, a seat disposed on the chassis, and a controlling apparatus disposed at two sides of the seat; wherein the rotating apparatus provides a rotor pivotally disposed on the chassis, a rotating wheel pivoted on the rotor, and a pedal disposed on the rotor. The controlling apparatus comprises a controlling wheel pivoted on the chassis, a pair of transmission assemblages separately disposed on the chassis for driving a rotation of the controlling wheel, and two controlling bars disposed to drive the transmission assemblage to operate respectively. Each of the transmission assemblage provides a controlling gear disposed on the controlling bar, a linking unit driven by the controlling gear, a driving gear driven by the linking unit and connected to the controlling wheel, and a unidirectional device disposed on the driving gear. Therefore, the user merely moves two controlling bars by hands from side to side to drive the transmission assemblage and create a dynamic force for activating the rotation of two controlling wheels. With the unidirectional device, the normal rotation of the driving gear of the transmission assemblage is not offset by a reverse force generated from the specific driving of the controlling gear, which allows the controlling wheels to rotate in one direction and increases the moving stability of the amusement vehicle. At the same time, stepping on the rotating apparatus by feet can control the rotating angle and move the vehicle forwards for generating a self-propelling sliding motion. Therefore, the fun of exercise and amusement in use is increased by using the motion of hands to control the speed of acceleration and using the stepping of feet to control the rotating angle of moving.

Preferably, the linking unit includes at least one linking gear.

Preferably, an adjusting unit is disposed at a bottom of the seat which is disposed on the chassis, and a plurality of holes are formed on the chassis for allowing the adjusting unit to insert and fasten therein correspondingly.

### BRIEF DESCRIPTION OF THE DRAWINGS

FIG. 1 is a schematic view showing a conventional torsion car 1;

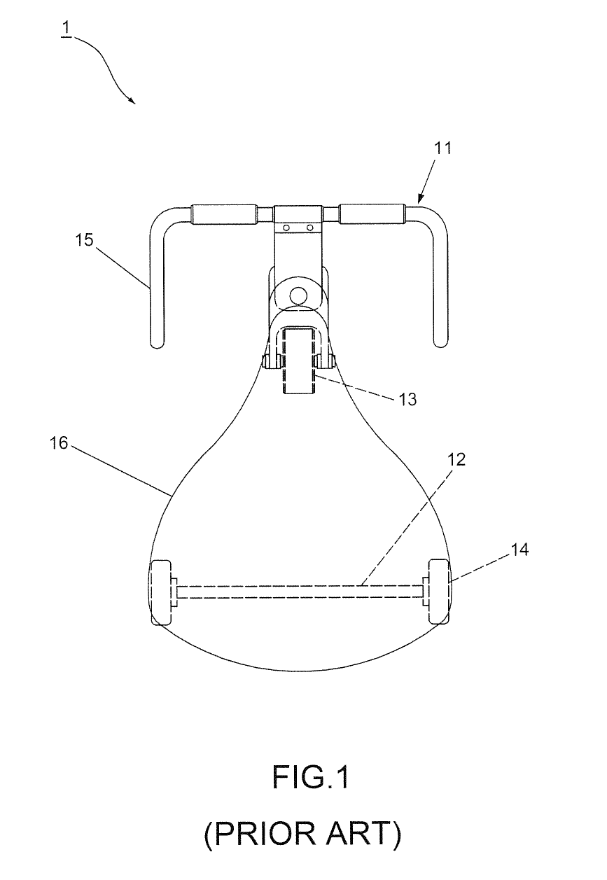

FIG. 2 is a perspective view showing a first preferred embodiment of the present invention;

FIG. 3 is an exploded view showing partial components of the first embodiment of the present invention;

FIG. 4 is an enlarged cross-sectional view showing partial components of the first embodiment of the present invention; and

FIG. 5 is an end view showing a second preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

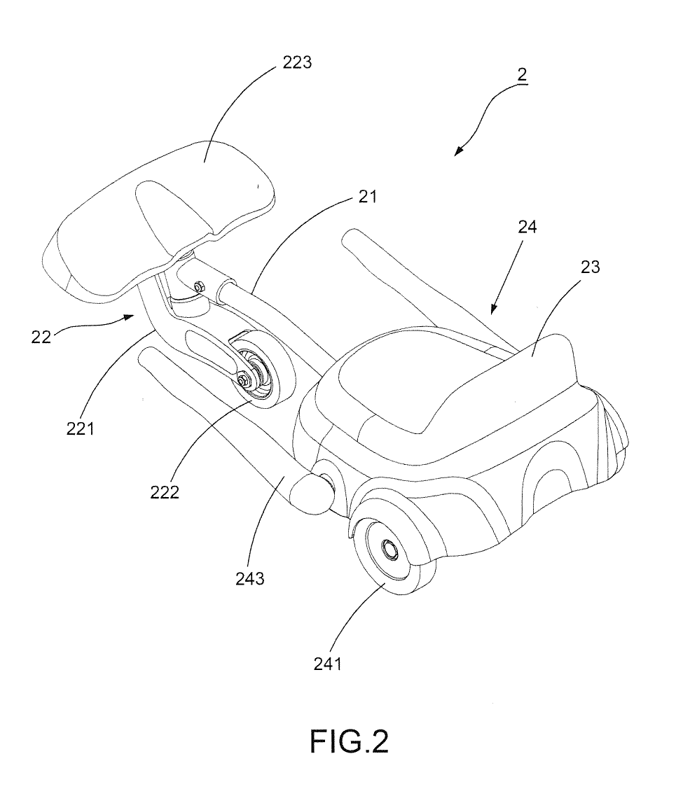

Referring to FIG. 2, a first preferred embodiment of the amusement vehicle with rowing-type auxiliary device 2 comprises a chassis 21, a rotating apparatus 22 pivoted on the chassis 21, a seat 23 disposed on the chassis 21, and a controlling apparatus 24 disposed on two sides of the seat 23; wherein the rotating apparatus 22 provides a rotor 221 pivotally disposed on the chassis 21, a rotating wheel 222 pivoted on the rotor 221, and a pedal 223 disposed on the rotor 221. In this embodiment, the rotor 221 is extended to be disposed in the back of the pedal 223, whereby the rotating wheel 222 and the controlling wheel 241 of the controlling apparatus 24 are constructed as a stable configuration to stably support the chassis 21 and the seat 23. The pedal 223 is connected to the rotor 221, and feet are put on the pedal 223. Consequently, the user can use the pedal 223 to control the rotating angle of the rotor 221 and further control the moving direction of the amusement vehicle with rowing-type auxiliary device 2.

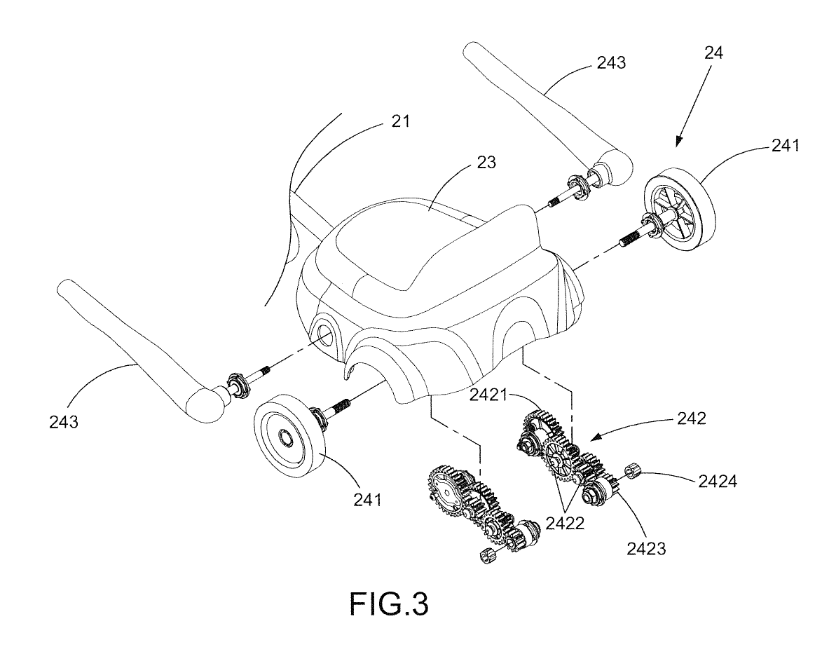

Referring to FIG. 3, the controlling apparatus 24 comprises a controlling wheel 241 pivoted on the chassis 21, a transmission assemblage 242 separately disposed on the chassis 21 for driving a rotation of the controlling wheels 241, and two controlling bars 243 disposed to drive the transmission assemblage 242 to operate respectively; wherein the transmission assemblage 242 provides a controlling gear 2421 disposed on the controlling bar 243, a linking unit 2422 driven by the controlling gear 2421, a driving gear 2423 driven by the linking unit 2422 and connected to the controlling wheel 241, and a unidirectional device 2424 disposed on the driving gear 2423. Accordingly, at the time of the reciprocating motion of the controlling bars 243, a dynamic force is generated and transmitted from the mutual meshing relation between the controlling gear 2421, the linking unit 2422, and the driving gears 2423 to the controlling wheel 241, thereby driving the controlling wheel 241 to rotate in one direction. Preferably, the linking unit 2422 includes at least one linking gear. Herein, there are two linking gears 2422 meshed together as illustrated, so that the transmission assemblage 242 can be integrally arranged as shown in FIG. 3. Alternatively, the transmission assemblage 242 can be set by a combination of rotating gears with a driving belt, namely a linking belt (not shown) can be disposed between the controlling gear 2421 and the driving gear 2423 for transmitting the dynamic force.

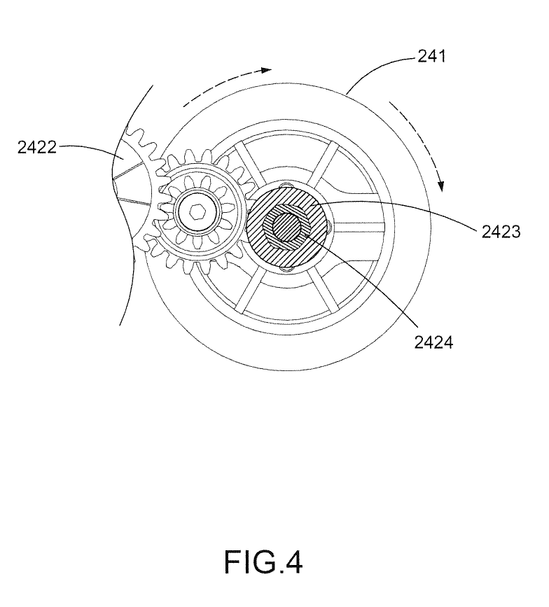

Referring to FIG. 2 and FIG. 3, while using, a user sits on the seat 23 and puts feet on the pedal 223. By stepping the feet on the pedal 223, the rotating angle of the rotor 221 can be controlled and adjusted. Further, user's hands hanging down on both sides of the seat 23 hold the controlling bars 243 respectively and activate the motion of the controlling bars 243 by some ways, such as pulling up one controlling bar 243 with one hand and pressing down the controlling bar 243 with the other hand alternately or simultaneously. By means of the reciprocating motion of the two controlling bars 243, a dynamic force derived from the motion is generated and sequentially transmitted from the controlling gears 2421 and the linking unit 2422 which are meshed together to the driving gear 2423. Then the driving gear 2423 uses the dynamic force to drive a regular and circular rotation of the controlling wheel 241. It is noted that when the driving gear 2423 is affected by the controlling gear 2421 and the linking unit 2422, a reverse force upon the driving gear 2423 may be incurred as one of the above motions of the controlling bar 243 may lead to a counterclockwise rotation of the driving gear 2423 e.g. the motion of pressing down or pulling up the controlling bar. By means of the unidirectional device 2424 which overcomes the reverse force, this reverse force does not offset the normal rotation of the driving gear 2423. As a result, the driving gear 2423 driven by the linking unit 2422 can only rotate the controlling wheel 241 in one direction (as arrowed in FIG. 4). Consequently, the moving stability of the amusement vehicle 2 is greatly increased. Further, the moving speed of the amusement vehicle 2 is adjustable by the operating speed of the transmission assemblage 242 which is controlled by the moving speed of user's hands. The rotating angle of the rotor 221 is controlled by putting feet on the pedal 223 and swinging the feet, thereby driving the rotating wheel 222 to move toward a direction where the user wishes to go and thus obtaining a self-propelling sliding effect of the amusement vehicle 2. Therefore, the present invention obtains the fun of amusement during the operation and attains the exercise effect of training hands and feet. The present invention is also adapted to different ages.

In addition, during the forward movement of the amusement vehicle with rowing-type auxiliary device 2, the moving direction can be not only controlled by the wiggles of feet but controlled by the wriggles of the waist, the buttocks, and other parts of the body, thereby stretching the whole body during the operation. Therefore, the user can exercise the whole body and control the moving speed at the same time. Consequently, by using the motion of hands to control the moving speed and using feet to control the rotating angle and the forward direction, the present invention can be operated with both hands and feet for increasing the fun of exercise and amusement of the use.

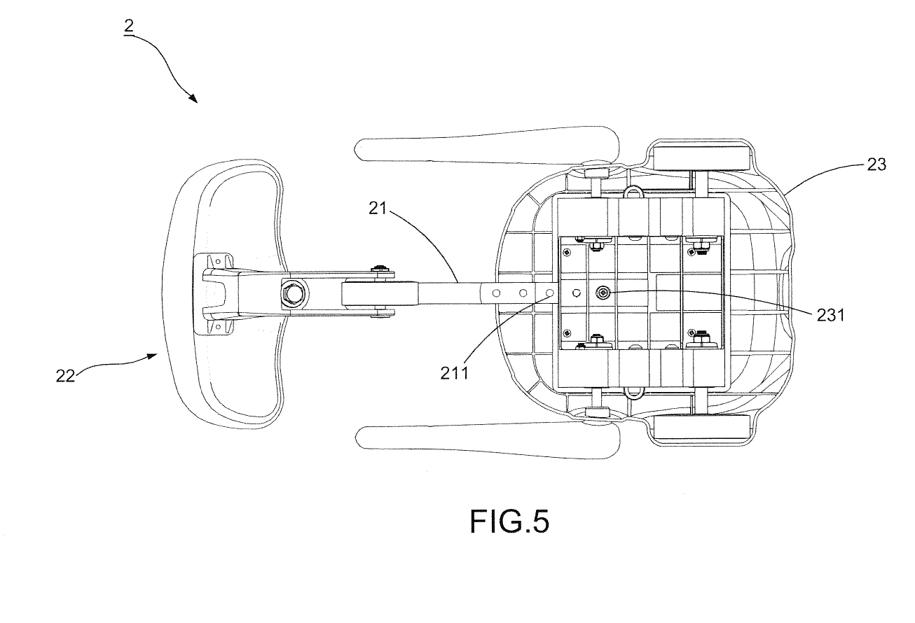

Referring to FIG. 5, a second preferred embodiment of the present invention shown in an end view still comprises the same components as the first embodiment. Particularly, this preferred embodiment can adjust the stepping length of feet. In this embodiment, an adjusting unit 231 is disposed at a bottom of the seat 23 which is disposed on the chassis 21. A plurality of holes 211 are defined on the chassis 21 for allowing the adjusting unit 231 to insert and fasten therein. Consequently, the user can properly adjust the distance between the seat 23 and the rotating apparatus 22 in accordance with the user's height to find a comfortable sitting position. During the adjustment, the release of the adjusting unit 231 on the seat 23 renders a loose connection between the seat 23 and the chassis 21, which allows the seat 23 to displace until the adjusting unit 231 is correspondingly inserted and fastened into one of the holes 211 on the chassis 21. Therefore, the distance between the seat 23 and the rotating apparatus 22 can be adjusted to increase the convenience of use.

To sum up, the amusement vehicle with rowing-type auxiliary device provides a rotating apparatus disposed at the front side of the chassis and a controlling apparatus disposed on both sides of the chassis. The user sits on the seat and moves the controlling bars of the controlling apparatus from side to side by hands for driving the controlling wheel to rotate and move forwards in one direction. Feet step on the rotating apparatus and control the rotating angle for moving to the direction where the user wants to go. Therefore, the user can obtain a dual controlling mode by hands and feet and enjoy the self-propelling sliding effect, whereby the fun of exercise and amusement in use is increased and the purpose of the present invention is exactly achieved.

While we have shown and described the embodiment in accordance with the present invention, it should be clear to those skilled in the art that further embodiments may be made without departing from the scope of the present invention.

What is claimed is:

1. An amusement vehicle with rowing-type auxiliary device comprising a chassis, a rotating apparatus pivoted on said chassis, a seat disposed on said chassis, and a controlling apparatus disposed at two sides of said seat; wherein said rotating apparatus provides a rotor pivotally disposed on said chassis, a rotating wheel pivoted on said rotor, and a pedal disposed on said rotor; said controlling apparatus including a controlling wheel pivoted on said chassis, a pair of transmission assemblages separately disposed on said chassis for driving a rotation of said controlling wheel, and two controlling bars disposed to drive said transmission assemblages to operate respectively; each of said transmission assemblage providing a controlling gear disposed on said controlling bars, a linking unit driven by said controlling gear, a driving gear driven by said linking unit and connected to said controlling wheel, and a unidirectional device disposed on said driving gear, whereby a reciprocating movement of said controlling bars transmits a dynamic force to said controlling gear, said linking unit, and said driving gear sequentially in order to drive said controlling wheel to rotate, and said dynamic force transmitted from said driving gear causes said controlling wheel to rotate in one direction by using said unidirectional device.

2. The amusement vehicle with rowing-type auxiliary device as claimed in claim 1, wherein said linking unit includes at least one linking gear.

3. The amusement vehicle with rowing-type auxiliary device as claimed in claim 1, wherein an adjusting unit is disposed at a bottom of said seat which is disposed on said chassis, and a plurality of holes are formed on said chassis for allowing said adjusting unit to insert and fasten therein correspondingly.
